(19) United States
(12) Patent Application Publication
(10) Pub. No.: US 2014/0122186 A1
(43) Pub. Date: May 1, 2014

(54) USE OF VIDEO TO MANAGE PROCESS QUALITY

(71) Applicant: Blaine E. Hurst, Dedham, MA (US)

(72) Inventor: Blaine E. Hurst, Dedham, MA (US)

(73) Assignee: Pumpernickel Associates, LLC, St. Louis, MO (US)

(21) Appl. No.: 13/837,940

(22) Filed: Mar. 15, 2013

Related U.S. Application Data
(60) Provisional application No. 61/720,533, filed on Oct. 31, 2012.

(51) Int. Cl. G06Q 10/06

(52) U.S. Cl. CPC G06Q 10/0639
USPC 705/7.38; 348/150

(57) ABSTRACT

Embodiments of the invention provide techniques for using video footage to manage the performance of business processes in a restaurant. In some embodiments, certain types of events to be evaluated are identified, such as those which relate to an order received from a customer in which the customer requests that a standard menu offering be customized in some way. Data describing various aspects of restaurant operations may be queried to identify occurrences of the specified event type, and records describing these occurrences may be identified. Information in the records may be used to retrieve corresponding video footage depicting the processes being performed, and the video footage may be analyzed to verify that processes are being performed as specified.

### RELATED APPLICATIONS

This application claims priority under 35 U.S.C. §119(e) to U.S. Provisional Application Ser. No. 61/720,533, filed Oct. 31, 2012, entitled “Use of Video to Manage Process Quality,” bearing Attorney Docket No. P0977.70000US00, the entirety of which is incorporated herein by reference.

### BACKGROUND

Video surveillance systems are used by businesses for a variety of different applications. For example, many businesses use video surveillance systems to help secure physical facilities, and to prevent loss from theft.

Some video surveillance systems include a large number of video surveillance cameras, which may be deployed at multiple locations. In such systems, a great deal of video footage may be captured and stored. (As used herein, the terms “video footage” and “video” are used to refer to not only the captured images depicting a particular setting, but also any captured audio recording of sounds, voices, etc., which corresponds to captured images.) As a result, it may be prohibitively expensive and impractical for some businesses to employ human operators to analyze all of the video footage that has been captured. Recognizing this, some conventional systems provide the capability to catalog video footage captured by multiple cameras, and to correlate video footage with other data describing depicted events, so that footage depicting particularly important events may be efficiently identified and analyzed.

### SUMMARY

The inventor has appreciated a novel application for video surveillance systems—i.e., to employ video footage to manage the performance of business processes. For example, some embodiments of the invention may involve using video footage to ensure that employees comply with predefined standards relating to the performance of certain processes. These processes may, in some embodiments of the invention, be processes performed in a restaurant, a or otherwise relate to restaurant operations. (As used herein, the term “restaurant” means any establishment where food or refreshments are prepared at least in part on-site, and may be purchased for consumption on-site and/or off-site.) For example, restaurant processes which may be analyzed using video footage may include food preparation processes, point-of-sale interactions, other employee-guest interactions, and/or any other process(es) relating to food quality or order accuracy. It should be appreciated, however, that embodiments of the invention are not limited to being used in relation to processes performed at a restaurant. For example, some embodiments of the invention may employ video footage to analyze processes performed at a food manufacturing facility, such as food production, packaging, and/or any other suitable processes.

In some embodiments of the invention, if analysis of video footage reveals that processes are not being performed as specified by the business, then feedback may be provided. For example, video footage showing employees performing processes differently than designed may be made available to a manager, who may use the video footage as a tool for training the employees.

Some embodiments of the invention provide a system in which video footage depicting events occurring within a restaurant may be correlated with data describing those events. The events may relate to certain processes which are performed in the restaurant, such as point-of-sale interactions (e.g., receipt and entry of customer orders), food preparation, delivery (i.e., transfer) of food to the customer, and/or any other suitable process(es) and/or other event(s). Correlation of video footage to data may be accomplished, for example, using date and time stamps which are associated with both the video footage and with individual records created by one or more systems in the restaurant. Specific types of events to be evaluated may be identified, and data created by restaurant systems may be queried to identify records describing occurrences of those events. The date and time stamps for the records may be used to extract video footage depicting the occurrences, and the video footage may be analyzed to determine whether processes are being performed as specified.

Any suitable type of event may be selected for evaluation. In a particular embodiment described in detail herein, a restaurant may wish to evaluate events which relate to a customer's order in which the customer requested that a “standard” menu offering be customized in some way, such as by adding, removing and/or modifying the item's ingredients, changing the way the item is assembled, and/or making other modifications. The restaurant may wish to assess, for example, the manner in which the order was received, the manner in which the food is prepared, the manner in which the food is delivered to the customer, and/or any other suitable processes or events. By analyzing video footage depicting occurrences of these types of events, the restaurant may determine whether processes are being performed by staff in the manner prescribed for these event types. If not, then steps may be taken to ensure that the processes are performed properly going forward.

### BRIEF DESCRIPTION OF DRAWINGS

The accompanying drawings are not intended to be drawn to scale. In the drawings, each identical or nearly identical component illustrated in the various figures is represented by a like numeral. For purposes of clarity, not every component may be labeled in every drawing. In the drawings:

FIG. 1 is a block diagram depicting an example system for capturing and using video to manage the performance of business processes, in accordance with some embodiments of the invention;

FIG. 2 is a flowchart depicting an example process for initiating extraction of video footage relating to occurrences of defined event types, in accordance with some embodiments of the invention;

FIG. 3 is a flowchart depicting an example process for analyzing video footage depicting business processes being performed, in accordance with some embodiments of the invention; and

FIG. 4 is a block diagram depicting an example computer system with which some aspects of the invention may be implemented.

### DESCRIPTION

Some embodiments of the invention provide techniques for using video footage to manage the performance of business processes. For example, in some embodiments, a business may identify certain types of events to be evaluated. Data describing various aspects of the business's operations may be queried to identify occurrences of these types of events. Records describing these occurrences may be identified, and the date and time stamps for the records may be used to extract corresponding video footage. Once extracted, the video footage may be analyzed to verify that processes are being performed as specified. If one or more of the processes are not being performed as specified, then corrective steps may be taken, such as by making extracted video footage available to a manager so that it may be used, for example, as a training tool.

One illustrative embodiment in which the business is a restaurant, and the event types to be evaluated relate to an order received from a customer in which the customer requests that a standard menu offering be customized in some way, is described in detail below. However, it should be appreciated that embodiments of the invention have wide applicability to businesses other than restaurants, and processes which are performed outside the restaurant context. For example, as noted above, any or all of the techniques described herein may be employed to analyze operations of a food manufacturing facility, and/or any other suitable business, operation or setting.

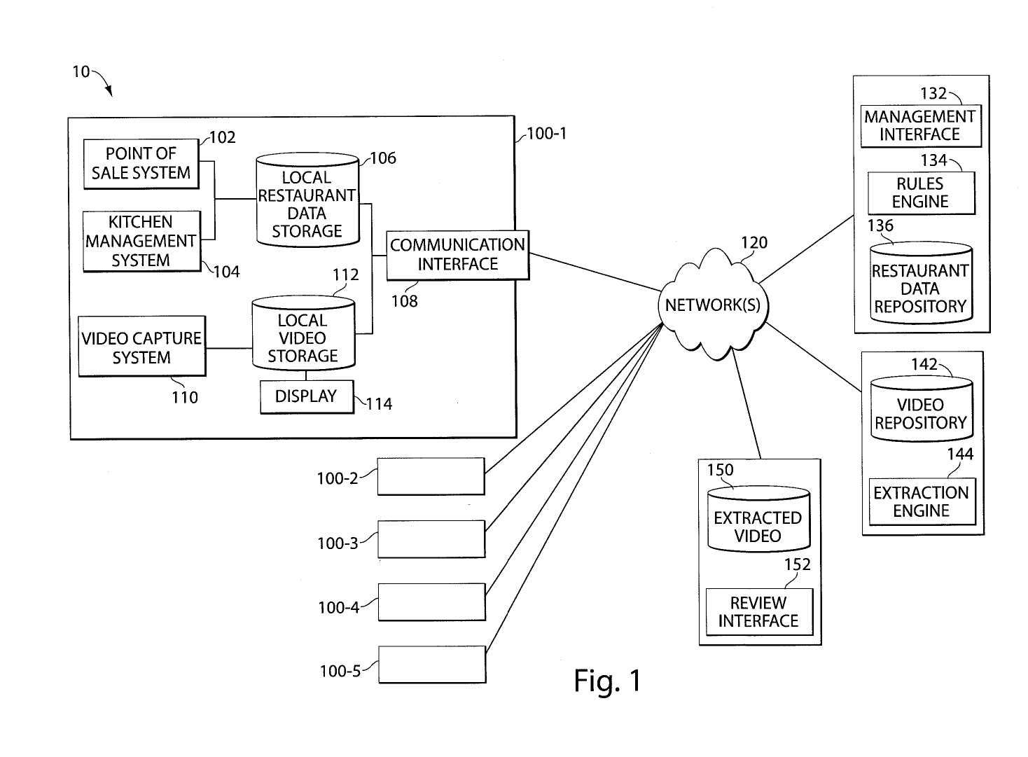

FIG. 1 depicts an example system 10 for capturing and analyzing video footage of processes performed in a restaurant, in accordance with some embodiments of the invention. In this example system, one set of system components (described below) is deployed within restaurant 100-1, and corresponding sets of components are deployed in other restaurants 100-2, 100-3, 100-4 and 100-n. It should be appreciated that system components may be implemented in any suitable number of restaurants, or other business locations, as embodiments of the invention are not limited in this respect.

In the example system 10 shown in FIG. 1, the system components deployed within restaurant 100-1 include point-of-sale (POS) system 102, kitchen management system 104, and local restaurant data storage 106. Although only two systems are shown in example system 1, it should be appreciated that in other implementations, any suitable number of systems may operate, each offering any suitable functionality.

Also deployed within restaurant 100-1 are one or more video capture devices (e.g., cameras) 110, local video storage 112 and display 114. Communication interface 108 enables one or more of the components deployed within restaurant 100-1 to communicate with components outside restaurant 100-1, as described below.

In example system 10, POS system 102 is used to perform point-of-sale interactions with customers of restaurant 100-1, such as to receive and enter customer orders, and collect information relating to those orders. In the example system 10, POS system 102 generates data describing those orders which is stored in local restaurant data storage 106. Local restaurant data storage 106 may comprise any one or more suitable storage devices and/or systems.

Also stored in local restaurant data storage 106 is data generated by kitchen management system 104. In the example system shown, kitchen management system 104 may be used to manage the preparation of food ordered by customers, such as by tracking the status of each customer order to completion, and/or other information.

In example system 10, local restaurant data storage 106 stores not only substantive data created by POS system 102 and kitchen management system 104 (e.g., describing orders) in the form of individual records, but also a date and time stamp for each record. A date and time stamp may record, for example, the time at which a particular record was created (e.g., to indicate the receipt of an order, to indicate an order being moved from one work cell to another along a food preparation “line,” or to indicate any other suitable occurrence).

In example system 10, one or more video capture devices 110 (e.g., one or more video surveillance cameras, although any suitable device(s) may be employed) are used within restaurant 100-1 to capture video footage depicting the performance of various processes. In the example system 10, video footage captured by video capture device(s) 110 is stored in local video storage 112, which may comprise any suitable device(s) for storing video data. Example system 10 also includes display 114, which may comprise any suitable device for allowing a human operator to view video stored in local video storage 112.

In example system 10, data which is stored in local restaurant data storage facility 106 and local video storage facility 112 is communicated via communication interface 108 and network(s) 120 to external storage components. Specifically, in the example system 10, data stored in local restaurant data storage facility 106 is communicated to, and stored by, restaurant data repository 136, and data stored in local video storage facility 112 is communicated to, and stored by, video repository 142. Data may be communicated from a local storage component to an external storage component using any suitable technique(s) and/or infrastructure, as embodiments of the invention are not limited to any particular manner of implementation. It should be appreciated that although restaurant data and video data are stored in separate repositories in example system 10, embodiments of the invention are not limited to such an implementation.

In example system 10, restaurant data repository 136 stores data received from not only restaurant 100-1 (i.e., from local restaurant data storage 106), but also from components deployed at restaurants 100-2, 100-3, 100-4 and 100-n. Similarly, video repository 142 stores video data received from not only local video storage facility 112 deployed in restaurant 100-1, but also from corresponding components deployed in 100-2, 100-3, 100-4 and 100-n. Restaurant data repository 136 and video repository 142 may each receive and store data from any suitable number of components, deployed at any suitable number of physically disparate restaurants. In some embodiments, restaurant data repository 136 and video repository 142 may each accept daily feeds (and/or feeds at any other suitable periodicity) from components deployed at various restaurants, and aggregate those feeds to create a comprehensive repository.

In example system 10, management interface 132 may be used (e.g., by a human operator) to define criteria characterizing the types of events which are to be evaluated. Any one or more criteria may be defined, in any suitable form and/or fashion. In one illustrative example, management interface 132 may be used to define criteria characterizing orders which involve some degree of customization requested by a customer. For example, management interface 132 may be used to specify criteria such as an order received at POS system 102 in which a customer exchanged a “standard” ingredient on a particular sandwich for another ingredient, an order handled by kitchen management system 106 for which a customer asked that salad ingredients be arranged differently than they would be normally, and/or any other suitable event type(s).

It should be appreciated that although management interface 132 is shown in FIG. 1 as being remote from restaurant 100-1, embodiments of the invention are not limited to such an implementation. For example, management interface 132 may be implemented within restaurant 100-1, or components comprising management interface 132 may be implemented in multiple locations (e.g., restaurants). Moreover, management interface 132 may comprise any suitable interface, including (as examples) a personal computer, network terminal, personal digital assistant (PDA), communication device (e.g., cellular telephone, “smartphone,” etc.), and/or any other suitable device(s).

In example system 10, criteria defined by management interface 132 are used by rules engine 134 to query restaurant data repository 136 to identify records associated with occurrences of defined event types. The output of a query may, for example, include a data structure which includes information from the records including its date and time stamp. Of course, other information may also, or alternatively, be extracted.

Data extracted from restaurant data repository 136, or a representation thereof, is communicated to extraction engine 144. In some embodiments, a date and time stamp for each extracted record may be used to extract video footage having the same, or a similar, date and time stamp, from video repository 142. Other information may also, or alternatively, be used to extract video footage. For example, if a record for which corresponding video footage is to be extracted originated from POS system 102, then this information may be used to identify the video footage to be extracted as that which depicts a point of sale terminal. Similarly, if a record for which video footage is to be extracted originated from kitchen management system 104, then this information may be used to identify the video footage to be extracted as that which depicts a food preparation area. Any suitable information may be used to extract video footage, whether provided by a system component residing within restaurant 100-1 or otherwise.

A time stamp for extracted video may have any suitable relationship to a time stamp for a corresponding record. For example, video footage extracted for a record may have the same time stamp as the record, one which indicates the video was captured thirty seconds prior to the time indicated by the record's time stamp, or one which indicates the video was captured at any suitable time interval before or after the time indicated by the record's time stamp.

In example system 10, video footage that is extracted from video repository 142 is transmitted to extracted video repository 150 for analysis. In this respect, a human operator may employ review interface 152 to review video footage of identified occurrences of the specified event types, such as to confirm that the processes captured in the footage comply with defined procedures. If not, the human operator may record an indication that the video footage is to be further reviewed, such as by a manager to demonstrate to employees how processes are to be performed.

It should be appreciated that example system 10 represents merely one manner of implementing components for capturing, storing and/or analyzing video footage depicting the performance of business processes, and that numerous other implementations are possible. For example, in some implementations, video footage may be captured and analyzed for processes performed at a single location (e.g., at a single restaurant), rather than for multiple locations, and as such, restaurant data and/or video footage may not be stored in a repository at a location which is remote from a restaurant. For example, in some implementations, video footage depicting occurrences within a restaurant may be stored only locally within the restaurant, such as with a digital video recorder and/or any other suitable device(s). Moreover, in some implementations, various system components may not reside in physically disparate locations. Additionally, in some implementations, business intelligence data and video data need not be stored both locally (e.g., in restaurant 100-1) and remotely (e.g., in restaurant data repository 134 and video repository 142). Numerous variations on example system 10 are possible.

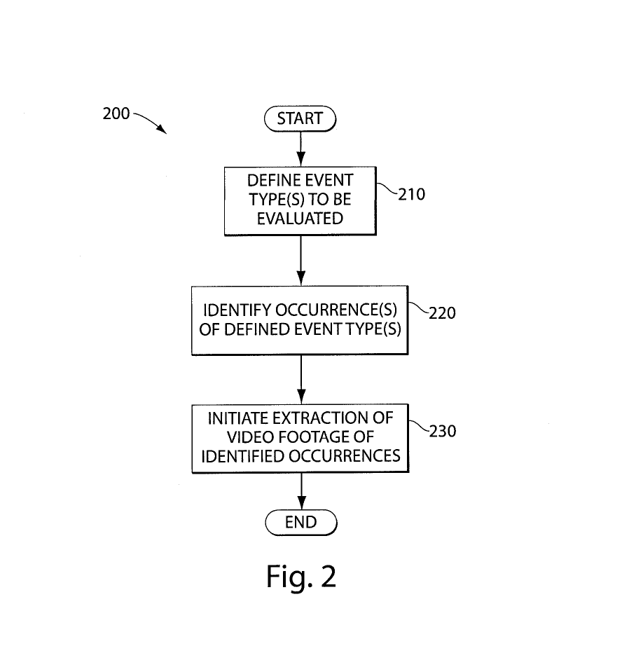

FIG. 2 depicts an example process 200 for identifying video footage for analysis. At the start of example process 200, one or more event types to be evaluated are specified in act 210. This may be performed in any suitable fashion. In some embodiments of the invention, a human operator may employ a management interface (e.g., management interface 132, FIG. 1) to specify criteria characterizing specific event types to be evaluated. In other embodiments, one or more automated processes may identify criteria characterizing event types to be evaluated. Criteria may be specified, and expressed and/or encoded, in any suitable fashion. Moreover, any suitable event type may be identified for evaluation.

In an embodiment in which the business processes to be evaluated relate to a restaurant order that is customized by a customer, the event types which are specified in act 210 may include, as examples, a point-of-sale interaction between customer and cashier in which a customized order was placed, preparation of a customized order by kitchen staff, delivery of prepared food resulting from a customized order to the customer, and/or other event types. Any suitable number and type of events may be specified in act 210, as embodiments of the invention are not limited in this respect.

Example process 200 then proceeds to act 220, wherein occurrences of the event types specified in act 210 are identified. This may be performed in any suitable fashion. In some embodiments of the invention, business intelligence data which describes events occurring at a particular location (e.g., restaurant) may be queried to identify occurrences of the specified event types. For example, data created by POS system 102 and/or kitchen management system 104, describing point-of-sale interaction events and food preparation events, respectively, may be queried to identify records describing specified event types. In some embodiments, the output of these queries may include not only substantive data describing each occurrence, but also a date and time stamp associated with each occurrence.

In an implementation in which business processes performed at multiple locations (e.g., restaurants 100-1, 100-2, 100-3, 100-4, and 100-n) are to be analyzed, as in the example system 10 shown in FIG. 1, rules engine 134 may execute queries on business intelligence data stored in restaurant data repository 136 to identify occurrences of specified event types. Numerous modes of implementation, involving evaluation of business processes at any suitable number of locations, are possible.

Example process 200 then proceeds to act 230, wherein extraction of video footage depicting the occurrences identified in act 220 is initiated. This may be performed in any of numerous ways. In some embodiments, a date and time stamp for each occurrence identified in the act 220 may be used to identify video footage depicting the identified occurrences. As noted above, a date and time stamp for video footage to be extracted need not exactly match a date and time stamp for an identified occurrence, as it may be desirable, for example, to extract video footage captured just before and just after the identified occurrence took place. For example, if the date and time stamp for an identified occurrence indicates that the occurrence began at a particular time, then video having a date and time stamp indicating that it was captured starting thirty seconds prior to that time may be extracted. Similarly, if the date and time stamp for an identified occurrence indicates that the occurrence ended at a particular time, then video having a date and time stamp indicating that it was captured ending thirty seconds after that time may be extracted. The date and time stamps for an identified occurrence and corresponding video footage may have any suitable relationship, as embodiments of the invention are not limited in this respect.

Other information may also, or alternatively, be used to initiate extraction of video footage. For example, if an event type to be evaluated relates to a point-of-sale interaction, then information identifying video footage as depicting a point-of-sale area may also be used to initiate extraction of the video footage. Any suitable information may be used to identify video footage to be extracted, as embodiments of the invention are not limited in this respect.

Extraction of video footage may be initiated in any of numerous ways. For example, in the example system 10 shown in FIG. 1, extraction engine 144 may submit queries to video repository 142 to initiate extraction of video footage, although any suitable technique(s) and/or system component(s) may be employed.

At the completion of act 230, example process 200 completes.

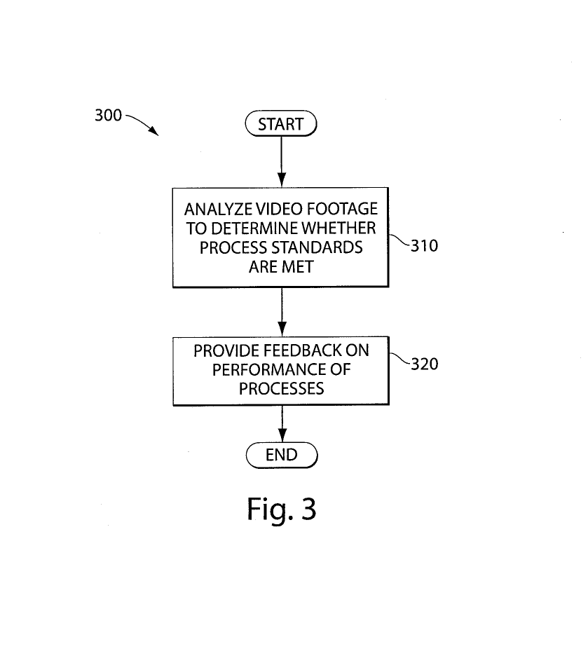

FIG. 3 depicts an example process 300 for analyzing extracted video footage to manage the performance of business processes. At the start of example process 300, video footage depicting a process being performed is analyzed to determine whether standards for the process are being followed. Analysis may be performed in any of numerous ways. For example, one or more human operators, automated processes, or a combination thereof may be employed to analyze video footage. Any suitable technique(s), involving the use of any suitable tool(s), may be used, whether now known or later developed.

Determining whether standards for a process are being followed may involve applying any of numerous factors. Using the example of a customized order given above with reference to FIG. 2 to illustrate, determining whether standards are followed may involve determining whether a cashier, in a point-of-sale interaction in which a customized order is received, reads back ingredients of the items which are customized; whether a customized order is assembled as prescribed, and moved between work cells by food preparation staff as prescribed; whether prepared food is subject to a final check prior to being delivered to customer; and/or determining whether any other suitable procedures are followed and/or standards are met.

At the completion of act 310, example process 300 proceeds to act 320, wherein feedback relating to the performance of business processes may be provided. For example, in some embodiments of the invention, a human operator who analyzes extracted video may identify and communicate standards which are not being consistently followed, staff members who may need additional training, areas which need overall improvement, and/or provide any other suitable feedback. In some embodiments of the invention, the operator may provide an indication of video footage depicting examples of areas needing improvement, or examples of a process being performed particularly well, so that a manager at a location may use that video footage as a training tool.

At the completion of act 320, example process 300 then completes.

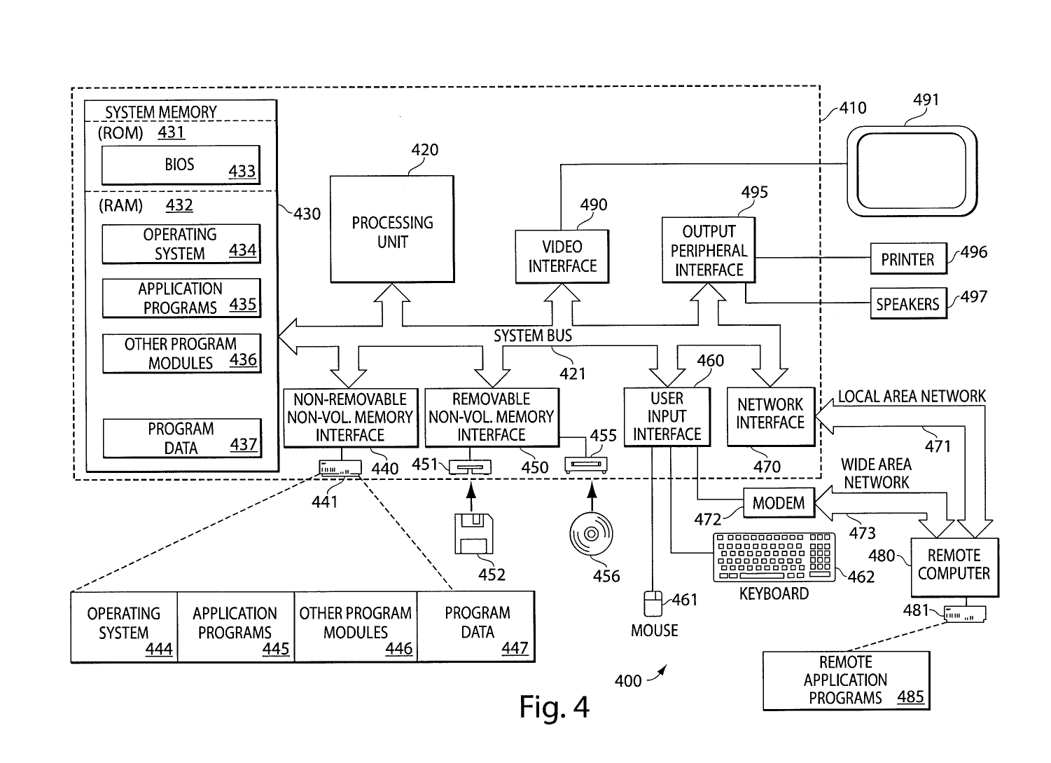

FIG. 4 illustrates an example of a suitable computing system environment 400 which may be used to implement aspects of the invention. The computing system environment 400 is only one example of a suitable computing environment, and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 4, an example system for implementing the invention includes a general purpose computing device in the form of a computer 410. Components of computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 410 typically includes a variety of computer readable media. Computer readable media can be any available media that can be accessed by computer 410 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436, and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through an non-removable memory interface such as interface 440, and magnetic disk drive 451 and optical disk drive 455 are typically connected to the system bus 421 by a removable memory interface, such as interface 450.

The drives and their associated computer storage media discussed above and illustrated in FIG. 4, provide storage of computer readable instructions, data structures, program modules and other data for the computer 410. In FIG. 4, for example, hard disk drive 441 is illustrated as storing operating system 444, application programs 445, other program modules 446, and program data 447. Note that these components can either be the same as or different from operating system 434, application programs 435, other program modules 436, and program data 437. Operating system 444, application programs 445, other program modules 446, and program data 447 are given different numbers here to illustrate that, at a minimum, they are different copies. A user may enter commands and information into the computer 410 through input devices such as a keyboard 462 and pointing device 461, commonly referred to as a mouse, trackball or touch pad. Other input devices (not shown) may include a microphone, joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. In addition to the monitor, computers may also include other peripheral output devices such as speakers 497 and printer 496, which may be connected through a output peripheral interface 495.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include a local area network (LAN) 471 and a wide area network (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460, or other appropriate mechanism. In a networked environment, program modules depicted relative to the computer 410, or portions thereof, may be stored in the remote memory storage device. By way of example, and not limitation, FIG. 4 illustrates remote application programs 485 as residing on memory device 481. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A system for managing operations of a restaurant, comprising:
a video surveillance system operable to capture video footage of events occurring in the restaurant;
at least one application operable to generate data describing events occurring in the restaurant;
a management interface enabling an operator to specify an event type to be evaluated, the type of event relating to food preparation, food delivery, and/or any process performed in the restaurant related to restaurant cleanliness, food quality or order accuracy; and
at least one retrieval component operable to retrieve (1) data generated by the at least one application relating to occurrences of the event type specified via the management interface, and (2) video footage captured by the video surveillance system depicting the occurrences of the specified event type.

2. The system of claim 1, wherein:
the data generated by the at least one application comprises a plurality of records, each record comprising a date and time stamp; and
the at least one retrieval component is operable to retrieve the video footage by using the date and time stamp for each retrieved record describing an occurrence of the specified event type to identify video footage depicting the occurrence of the specified event type.

3. A method of identifying video footage to be analyzed, the method comprising acts of:
(A) specifying an event type to be evaluated, the event type relating to food preparation, food delivery, and/or any process performed in a restaurant related to restaurant cleanliness, food quality or order accuracy;
(B) identifying occurrences of the specified event type;
(C) initiating retrieval of video footage depicting the occurrences identified in (C).

4. The method of claim 3, wherein:
the act (B) comprises retrieving records, generated by at least one application, each describing an occurrence of the specified event type, each comprising a date and time stamp; and
the act (C) comprises using the date and time stamp for each retrieved record to identify the video footage depicting the occurrence of the specified event type.

5. A method of employing video footage to manage process performed within a restaurant, the method comprising acts of:
(A) analyzing video footage depicting occurrences of a type of event within the restaurant, the type of event involving, food preparation, food delivery, and/or any process performed in the restaurant related to restaurant cleanliness, food quality or order accuracy, the analyzing comprising determining whether each occurrence conforms to a predefined standard for the process; and
(B) providing feedback relating to performance of the process.

6. The method of claim 5, wherein the act (B) comprises making at least a portion of the video footage available for use in training employees of the restaurant.

7. The method of claim 5, wherein the analyzing in the act (A) is performed at least in part by an automated process.

8. The method of claim 5, wherein the type of event relates to an order of a food item by a customer, the order involving the customer specifying a manner in which the food item is to be customized.

9. The method of claim 5, comprising an act of: (C) analyzing data associated with the video footage, the data describing the occurrences of the type of event.

10. The system of claim 2, wherein the plurality of records generated by the at least one application each describe an aspect of an event, and wherein each of the plurality of records has an associated date and time stamp.

11. The system of claim 10, wherein the management interface enables an operator to specify an event type which involves an order of a food item by a customer, the order involving the customer specifying a manner in which the food item is to be customized.

12. The system of claim 1, comprising a review interface enabling an operator to review the video footage retrieved by the at least one retrieval component.

13. The system of claim 12, wherein the review interface enables an operator to analyze data relating to occurrences of the event type specified using the management interface.

14. The system of claim 1, comprising at least one storage component operable to store the video footage captured by the video surveillance system and the data generated by the at least one application.

15. The system of claim 14, wherein the at least one retrieval component is operable to retrieve data and video footage stored by the at least one storage component.

16. The method of claim 3, wherein the act (B) comprises retrieving, from data describing events occurring in the restaurant, data relating to identified occurrences of the specified event type.

17. The method of claim 16, wherein the act (B) comprises retrieving a plurality of records each describing an aspect of an event of the specified event type.

18. The method of claim 3, wherein the specified event type relates to an order of a food item by a customer, the order involving the customer specifying a manner in which the food item is to be customized.

19. The method of claim 3, comprising an act, performed prior to the act (A), of causing the data retrieved in the act (B) and the video footage retrieved in the act (C) to be stored by at least one storage component.

20. The method of claim 19, wherein the act (B) comprises retrieving the data from the at least one storage component, and the act (C) comprises retrieving the video footage from the at least one storage component.

21. The method of claim 3, comprising an act of: (D) causing the video footage retrieved in the act (C) to be displayed to a user.

22. The method of claim 3, comprising an act of: (D) causing at least a portion of the data retrieved in the act (B) to be displayed to a user.

23. At least one storage device having instructions encoded thereon which, when executed by at least one computer, perform a method comprising acts of:
(A) receiving input specifying an event type to be evaluated, the event type relating to food preparation, food delivery, and/or any process performed in a restaurant relating to restaurant cleanliness, food quality or order accuracy;
(B) identifying occurrences of the specified event type;
(C) initiating retrieval of video footage depicting the occurrences identified in the act (B).

24. The at least one storage device of claim 23, wherein the act (B) comprises retrieving, from data describing events occurring in the restaurant, data relating to identified occurrences of the specified event type.

25. The at least one storage device of claim 24, wherein:
the act (B) comprises retrieving records, generated by at least one application, each describing an occurrence of the specified event type, each comprising a date and time stamp; and
the act (C) comprises using the date and time stamp for each retrieved record to identify video footage depicting the occurrence of the specified event type.

26. The at least one storage device of claim 25, wherein the act (B) comprises retrieving a plurality of records each describing an aspect of an event of the specified event type.

27. The at least one storage device of claim 23, wherein the specified event type relates to an order of a food item by a customer, the order involving the customer specifying a manner in which the food item is to be customized.

28. The at least one storage device of claim 23, comprising an act, performed prior to the act (A), of causing the data retrieved in the act (B) and the video footage retrieved in the act (C) to be stored by at least one storage component.

29. The at least one storage device of claim 28, wherein the act (B) comprises retrieving the data from the at least one storage component, and the act (C) comprises retrieving the video footage from the at least one storage component.

30. The at least one storage device of claim 23, comprising an act of: (D) causing the video footage retrieved in the act (C) to be displayed to a user.

31. The at least one storage device of claim 23, comprising an act of: (D) causing at least a portion of the data retrieved in the act (B) to be displayed to a user.
